(19) United States
(12) Patent Application Publication
(10) Pub. No.: US 2010/0278517 A1
(43) Pub. Date: Nov. 4, 2010

(54) VIDEO DECODING DEVICE

(75) Inventors: Naoki Sakata, Osaka (JP); Kengo Nishimura, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/681,822

(22) PCT Filed: Jul. 22, 2008
(86) PCT No.: PCT/JP2008/001953

§ 371 Date: Apr. 6, 2010

(30) Foreign Application Priority Data
Oct. 23, 2007 (JP) 2007-275705

(51) Int. Cl. H04N 5/93

(52) U.S. Cl. 386/357; 386/E05.001

(57) ABSTRACT

A video decoding apparatus (100) according to an implementation of the present invention includes: a dummy-packet inserting unit (105A) which inserts a dummy packet (221) into a boundary between a section (TS1) and a section (TS2) in a video stream (131); a DEMUX unit (106) which separates a video stream (132) into which the dummy packet (221) is inserted, into visual streams (133 and 135) and audio streams (134 and 136); a seamless detection unit (107) which detects a position at which the dummy packet (221) is inserted, as the boundary in the visual streams (133 and 135) and the audio streams (134 and 136); and a decoding unit (109) which decodes the visual streams (133 and 135) and the audio streams (134 and 136) and performs seamless reproduction on the boundary detected by the seamless detection unit (107).

### TECHNICAL FIELD

The present invention relates to video decoding devices, and relates particularly to a video decoding device which decodes, in parallel, plural visual data streams and plural audio data streams which are multiplexed into one or more video data streams divided into sections and which are to be simultaneously reproduced.

### BACKGROUND ART

Recently, an optical disk has been developed as a high-density recordable information medium. For example, a digital versatile disc (DVD) is generally widespread as an optical disk for recording movies and music. In addition, a Blu-ray disc (BD), which allows realizing large-volume and high-speed transmission, attracts attention as a future optical disk.

On the BD, a video data stream in which coded visual data and audio data are multiplexed (hereinafter, also simply described as “video stream”) is recorded. A DVD-compatible or BD-compatible reproduction apparatus includes a video decoding device which decodes coded visual and audio data.

Here, for the BD, there is a case where plural reproduction methods can be selected for recording the content. For example, for the movie, it is possible to reproduce a theatrical version and a full-length version which includes a scene that is not included in the theatrical version.

In this case, for example, on the BD, full-length visual and audio data are recorded in a reproduction order. When the theatrical version is selected, the reproduction apparatus reproduces the visual and audio data in the theatrical version by skipping part of the visual and audio data that is included in the full-length version.

Thus, when performing reproduction by skipping the part of the visual and audio data, the visual and audio data preceding and succeeding the skipped data are not always sequential. In some cases, this causes an interruption in images and sound.

In addition, when, in fast speed reproduction, reproducing a chapter boundary, reproducing visual and audio data edited by the user, and so on, there is a case where an interruption is caused in images and sound.

To deal with this problem, a known technique is to perform seamless reproduction on visual and audio data (for example, see Patent Reference 1). Seamless reproduction is to reproduce the data without interruption between images.

A conventional video decoding device described in Patent Reference 1 realizes seamless reproduction by inserting a dummy packet into a boundary of non-sequential video streams.

Patent Reference 1: International Publication Pamphlet No. 2005/002221

### DISCLOSURE OF INVENTION

### Problems that Invention is to Solve

However, for a conventional video decoding device, no method is described for performing seamless reproduction when plural video streams are inputted at the same time, and decoded and reproduced at the same time. That is, the conventional video decoding device cannot always perform seamless reproduction as required when simultaneously reproducing plural streams.

For example, in a new BD scheme, there is a case where plural streams such as In-mux and Out-of-mux are simultaneously reproduced. In-mux is a case where one video stream in which plural audio data streams and plural visual data streams are multiplexed is transferred, and Out-of-mux is a case where plural audio data streams and plural visual data streams are divided into plural video streams to be transmitted.

Thus, the object of the present invention is to provide a video decoding device which can decode plural video streams at the same time and can also perform seamless reproduction on the plural video streams.

### Means to Solve the Problems

In order to achieve the above object, a video decoding device according to an aspect of the present invention is a video decoding device which decodes, in parallel, a first visual data stream, a second visual data stream, a first audio data stream, and a second audio data stream which are multiplexed in one or more video data streams divided into sections and which are to be simultaneously reproduced, and the video decoding device includes: a dummy-packet inserting unit which inserts a dummy packet into a boundary between the sections in the one or more video data streams; a separating unit which separates the one or more data streams into which the dummy packet is inserted by the dummy-packet inserting unit, into the first visual data stream, the second visual data stream, the first audio data stream, and the second audio data stream; a detection unit which detects a position at which the dummy packet is inserted as a boundary between the first visual data stream, the second visual data stream, the first audio data stream, and the second audio data stream that have been separated from each other by the separating unit; a first visual decoding unit which decodes the first visual data stream separated by the separating unit, and performs, on the boundary detected by the detection unit, processing for reproducing images without interruption; a second visual decoding unit which decodes the second visual data stream separated by the separating unit, and performs, on the boundary detected by the detection unit, the processing for reproducing images without interruption; a first audio decoding unit which decodes the first audio data stream separated by the separating unit, and performs, on the boundary detected by the detection unit, processing for reproducing sound without interruption; and a second audio decoding unit which decodes the second audio data stream separated by the separating unit, and performs, on the boundary detected by the detection unit, the processing for reproducing sound without interruption.

With this configuration, the video decoding device according to an aspect of the present invention can decode plural video streams at the same time, using plural decoding units. Furthermore, the video decoding device according to an aspect of the present invention can perform seamless reproduction on the plural video streams by inserting a dummy packet into a boundary of video stream sections and identifying a stream boundary based on the dummy packet.

In addition, the dummy-packet inserting unit inserts the dummy packet including first information that indicates whether or not to specify each of the first visual decoding unit, the second visual decoding unit, the first audio decoding unit, and the second audio decoding unit, and the first visual decoding unit, the second visual decoding unit, the first audio decoding unit, and the second audio decoding unit perform, when specified by the first information, the processing for reproducing the images or the sound without interruption, on the boundary detected by the detection unit.

With this configuration, the video decoding device according to an aspect of the present invention can selectively perform seamless reproduction by specifying the stream boundary for an arbitrary data stream among the plural visual data streams and plural audio data stream.

In addition, the dummy-packet inserting unit inserts the dummy packet including second information that indicates a type of the processing for reproducing the images or the sound without interruption, the detection unit further detects the type of the processing for reproducing the images or the sound without interruption, the type being indicated by the second information, and the first visual decoding unit, the second visual decoding unit, the first audio decoding unit, and the second audio decoding unit perform, on the boundary detected by the detection unit, the processing according to the type for reproducing the images or the sound without interruption, the type being detected by the detection unit.

With this configuration, the video decoding device according to an aspect of the present invention can perform seamless reproduction of an arbitrary type on the plural visual data streams and plural audio data streams.

In addition, the dummy-packet inserting unit inserts the dummy packet including third information for identifying one of the sections that is located immediately after the dummy packet, the detection unit detects the third information included in the dummy packet, and associates the detected third information with each of the first visual data stream, the second visual data stream, the first audio data stream, and the second audio data stream that have been separated from each other by the separating unit, and the first visual decoding unit, the second visual decoding unit, the first audio decoding unit, and the second audio decoding unit perform the processing for reproducing the images or the sound without interruption, on the first visual data stream, the second visual data stream, the first audio data stream, and the second audio data stream, assuming that the first visual data stream, the second visual data stream, the first audio data stream, and the second audio data stream that are associated with same third information are to be reproduced at a same time.

With this configuration, the video decoding device according to an aspect of the present invention can determine the data to be simultaneously reproduced, from among the data included in each of the plural visual data streams and plural audio data streams, so as to perform seamless reproduction.

In addition, a video decoding method according to an aspect of the present invention is a video decoding method for decoding, in parallel, a first visual data stream, a second visual data stream, a first audio data stream, and a second audio data stream which are multiplexed in one or more video data streams divided into sections and which are to be simultaneously reproduced, and the video decoding method includes: inserting a dummy packet into a boundary between the sections in the one or more video data streams; separating the one or more data streams into which the dummy packet is inserted, into the first visual data stream, the second visual data stream, the first audio data stream, and the second audio data stream; detecting a position at which the dummy packet is inserted as a boundary between the first visual data stream, the second visual data stream, the first audio data stream, and the second audio data stream that have been separated from each other in the separating; and decoding, in parallel, the first visual data stream, the second visual data stream, the first audio data stream, and the second audio data stream that have been separated from each other in the separating, and performing, on the boundary detected in the detecting, processing for reproducing images and sound without interruption.

With this configuration, the video decoding device according to an aspect of the present invention can decode plural video streams at the same time. Furthermore, the video decoding method according to an aspect of the present invention allows performing seamless reproduction on the plural video streams by inserting a dummy packet into a boundary of sections in the video streams and identifying a stream boundary based on the dummy packet.

Note that the present invention can be realized not only as such a video decoding device and a video decoding method but also as a program that causes a computer to execute characteristic steps included in the video decoding method. Moreover, it goes without saying that such a program can be distributed through a transmission medium including a recording medium such as the CD-ROM, and the Internet.

### Effects of the Invention

In the manner described above, it is possible to provide a video decoding device which can decode plural video streams at the same time and can also perform seamless reproduction on the plural video streams.

### BRIEF DESCRIPTION OF DRAWINGS

FIG. 1 is a block diagram showing a configuration of a video decoding device according to an embodiment of the present invention.

FIG. 2 is a diagram showing an example of display of video data decoded by the video decoding device according to the embodiment of the present invention.

FIG. 3 is a block diagram showing a configuration of a dummy packet according to the embodiment of the present invention.

FIG. 4 is a diagram showing a flow of streams of a first example of operation of the video decoding device according to the embodiment of the present invention.

FIG. 5 is a diagram showing a configuration of a stream in the first example of operation of the video decoding device according to the embodiment of the present invention.

FIG. 6 is a diagram showing a configuration of a stream after a dummy packet is inserted in the first example of operation of the video decoding device according to the embodiment of the present invention.

FIG. 7 is a diagram showing a configuration of demuxed streams in the first example of operation of the video decoding device according to the embodiment of the present invention.

FIG. 8 is a diagram showing a configuration of streams after a dummy packet is inserted in a second example of operation of the video decoding device according to the embodiment of the present invention.

FIG. 9 is a diagram showing a configuration of demuxed streams in the second example of operation of the video decoding device according to the embodiment of the present invention.

FIG. 10 is a diagram showing a flow of streams in a third example of an operation of the video decoding device according to the embodiment of the present invention.

FIG. 11 is a diagram showing a configuration of streams in the third example of operation of the video decoding device according to the embodiment of the present invention.

FIG. 12 is a diagram showing a configuration of streams after a dummy packet is inserted in the third example of operation of the video decoding device according to the embodiment of the present invention.

FIG. 13 is a diagram showing a configuration of demuxed streams in the third example of operation of the video decoding device according to the embodiment of the present invention.

FIG. 14 is a diagram showing a flow of streams in a fourth example of operation of the video decoding device according to the embodiment of the present invention.

FIG. 15 is a diagram showing a configuration of streams in the fourth example of operation of the video decoding device according to the embodiment of the present invention.

FIG. 16 is a diagram showing a configuration of streams after a dummy packet is inserted in the fourth example of operation of the video decoding device according to the embodiment of the present invention.

### NUMERICAL REFERENCES

100 Video decoding device

101 File system control unit

102 Reproduction control unit

103 Stream control unit

104A, 104B Data transfer unit

105A, 105B Dummy-packet inserting unit

106 DEMUX unit

107 Seamless detection unit

108 Decoding control unit

109 Decoding unit

110 First visual decoding unit

111 First audio decoding unit

112 Second visual decoding unit

113 Second audio decoding unit

114 AV input-output control unit

115 AV input-output unit

120 Recording medium

121 HDD

131, 132, 133, 134, 135, 136, 141, 142, 143, 144, 145, 146, 147, 148, 151, 152, 153, 154, 155, 156, 157, 158 Stream

200 Main image

201 Sub image

210 TS header

211 TS payload

212 PID

213 SubSequenceNo

214 Dummy_ID

215 Buffer_indicate

220, 221, 222, 223, 224, 225, 226, 227, 228, 229, 230, 231 Dummy packet

### BEST MODE FOR CARRYING OUT THE INVENTION

Hereinafter, an embodiment of a video decoding device according an implementation of the present invention is described in detail with reference to the drawings.

The video decoding device according to an embodiment of the present invention includes plural decoding units which decode plural video streams at the same time, and inserts, into a boundary of video streams that are not sequential, a dummy packet including information that specifies the plural decoding units.

First, a configuration of the video decoding device according to the embodiment of the present invention is described.

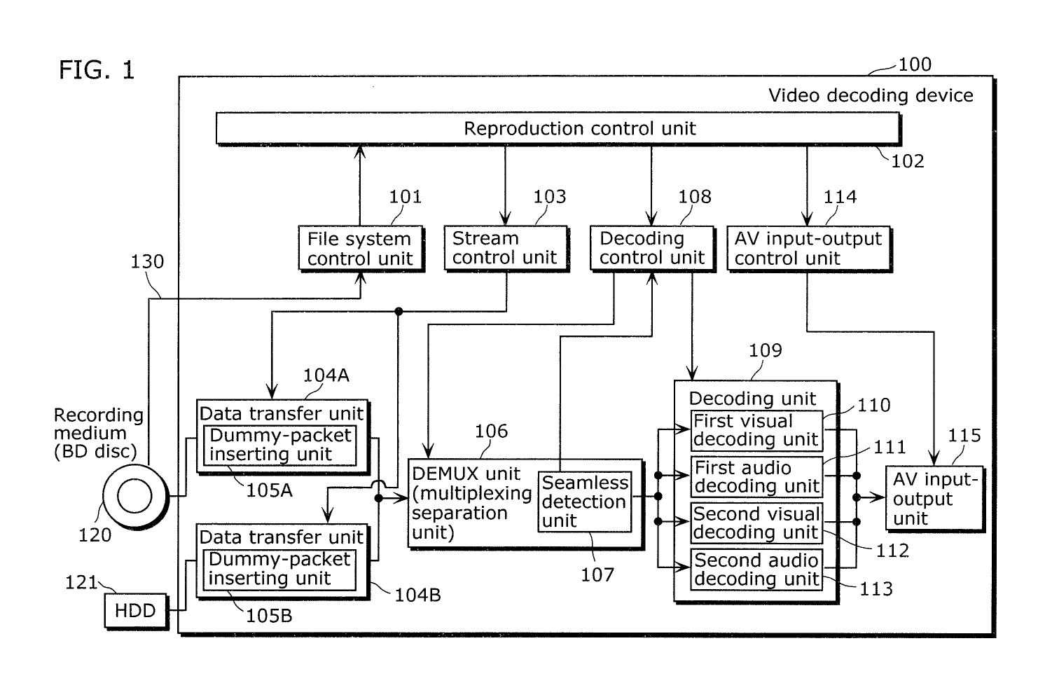

FIG. 1 is a block diagram showing a configuration of the video decoding device according to the embodiment of the present invention.

A video decoding device 100 shown in FIG. 1 is a video decoding device included in a reproduction apparatus which reproduces, for example, a BD and a DVD. The video decoding device 100 decodes video data recorded on a recording medium 120 and a hard disk drive (HDD) 121 and outputs the decoded video data.

The recording medium 120 is, for example, the BD. A HDD 121 is, for example, a HDD included in the reproduction apparatus.

For example, the video streams recorded on the recording medium 120 and the HDD 121 are video streams in accordance with MPEG2-TS. In MPEG2-TS, visual data streams and audio data streams are multiplexed and transferred as a transport stream (hereinafter, also described as “TS”).

In addition, in a new BD scheme, there is a case where plural streams are simultaneously reproduced, such as In-mux and Out-of-mux. Specifically, In-mux is a case where a TS in which plural audio data streams and plural visual data streams are multiplexed is transferred from the recording medium 120, and Out-of-mux is a case where plural audio data streams and plural visual data streams are divided into a TS to be transferred from the recording medium 120 and a TS to be transferred from the HDD 121, and are transferred.

In addition, in In-mux and Out-of-mux, each of the multiplexed plural visual data streams and plural audio data streams is simultaneously reproduced. For example, the multiplexed plural visual data streams and plural audio data streams are visual data streams and audio data streams corresponding, respectively, to a main image and a sub image which are simultaneously displayed.

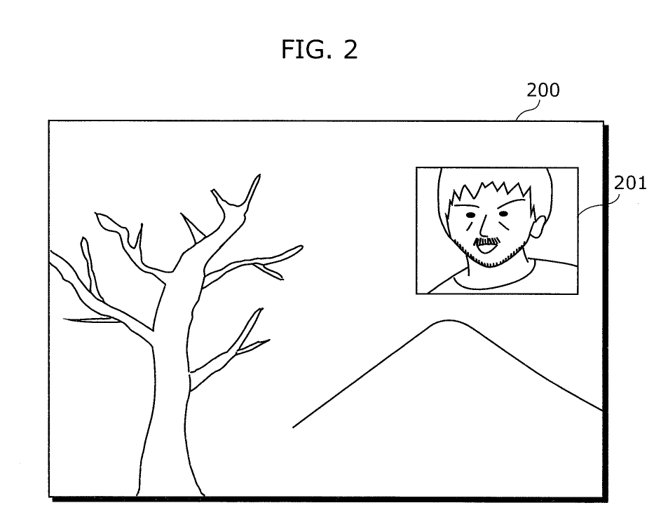

FIG. 2 is a diagram showing an example of display of the video data decoded by the video decoding device 100. As FIG. 2 shows, a sub image 201 is laid out in a portion of a main image 200. For example, with a BD on which a movie is recorded, a movie image is displayed as the main image 200, and an image such as a director's comment corresponding to the scene of the main image 200 is displayed as the sub image.

In addition, in fast speed reproduction, in the cases of reproducing a chapter boundary, reproducing visual and audio data edited by the user, and so on, the video streams transferred from the recording medium 120 and the HDD 121 include sections that are temporally unsequential.

In other words, the video decoding device 100 decodes, in parallel, plural visual data and plural audio data which are multiplexed into one or more video data streams divided into unsequential sections and which are to be simultaneously reproduced. Specifically, the video decoding device 100 decodes, into two visual elementary streams and two audio elementary streams, one or more TSs in which two visual data and two audio data are multiplexed, and further decodes the two visual elementary streams and the two audio elementary streams into a video picture and an audio frame.

Here, unsequential sections are the sections likely to cause interruption or overlapping in images and sound at a section boundary when directly reproducing the preceding and succeeding sections as they come; specifically, they are the sections where, in some cases, presentation time stamps (PTS) are not sequential at the section boundary. PTS is temporal information for synchronous reproduction of an image and sound, and is a time stamp indicating a time at which to reproduce the images and the sound.

The video decoding device 100 includes: a file system control unit 101, a reproduction control unit 102, a stream control unit 103, a data transfer unit 104A, a data transfer unit 104B, a DEMUX unit 106, a decoding control unit 108, a decoding unit 109, an AV input-output control unit 114, and an AV input-output unit 115.

The file system control unit 101 obtains management information 130 recorded on the recording medium 120. The management information 130 includes information on a reproduction stream. The information on the reproduction stream includes information such as a position (address) of a packet included in the stream and a type of seamless reproduction. In addition, the file system control unit 101 holds management information on the video data held by the HDD 121.

The reproduction control unit 102 obtains the information on the reproduction stream, which information is included in: the management information 130 obtained by the file system control unit 101, and the management information held by the file system control unit 101. The reproduction control unit 102 instructs the stream control unit 103 to perform stream transfer, based on the obtained information on reproduction stream.

In addition, the reproduction control unit 102 instructs the decoding control unit 108 to perform decoding. The reproduction control unit 102 instructs the AV input-output control unit 114 to perform an AV input and output.

The stream control unit 103 instructs the data transfer units 104A and 104B to perform stream transfer and dummy packet insertion, based on the instruction from the reproduction control unit 102.

The data transfer unit 104A reads the video data recorded on the recording medium 120 as a TS. The data transfer unit 104B reads the video data recorded on the HDD 121 as a TS.

The data transfer unit 104A includes a dummy-packet inserting unit 105A. The dummy-packet inserting unit 105A inserts a dummy packet into a stream boundary in the TS read by the data transfer unit 104A. Here, the stream boundary is a boundary of unsequential sections included in the TS.

The data transfer unit 104B includes a dummy-packet inserting unit 105B. The dummy-packet inserting unit 105B inserts a dummy packet into a stream boundary in the TS read by the data transfer unit 104B, and performs outputting.

Each of the data transfer units 104A and 104B outputs, into the DEMUX unit 106, the TS in which the dummy packet is inserted by the dummy-packet inserting units 104A and 105B.

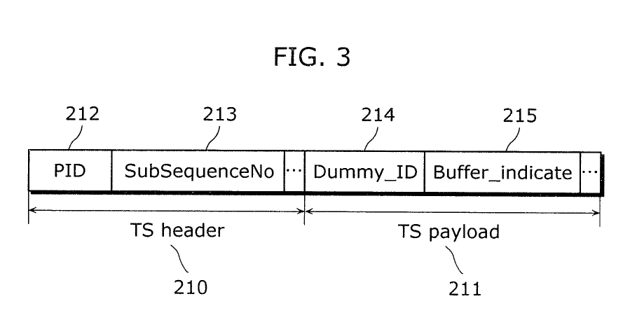

FIG. 3 is a diagram showing a configuration of the dummy packet inserted by the data transfer units 104A and 104B.

As FIG. 3 shows, the dummy packet includes a TS header 210 and a TS payload 211. The TS header 210 includes PID 212 and SubSequenceNo 213. TS payload 211 includes Dummy_ID 214 and Buffer_indicate 215.

PID 212 is information indicating that the packet is a dummy packet.

SubSequenceNo 213 is information for uniquely identifying the TS in the section located immediately succeeding the dummy packet.

Dummy_ID 214 is information indicating the type of seamless reproduction.

Buffer_indicate 215 is information indicating whether or not to specify each of the plural decoding units included in the decoding unit 109 (a first visual decoding unit 110, a first audio decoding unit 111, a second visual decoding unit 112, and a second audio decoding unit 113), and is information indicating to which decoding unit the visual data packet and the audio data packet included in the TS are to be transferred. Specifically, Buffer_indicate 215 is made up of 4 bits. The bits correspond, respectively, to: the first visual decoding unit 110, the first audio decoding unit 111, the second visual decoding unit 112, and the second audio decoding unit 113.

The DEMUX unit 106 is a multiplexing separation unit which separates multiplexed visual data streams and audio data streams into TSs to be outputted by the data transfer unit 104A and 104B. The DEMUX unit 106 outputs the separated visual data streams and audio data streams as visual elementary streams (hereinafter, also described as “visual streams”) and audio elementary streams (hereinafter, also described as “audio streams”), respectively. The DEMUX unit 106 includes a seamless detection unit 107.

The seamless detection unit 107 detects the dummy packet included in the TS outputted by the data transfer units 104A and 104B. Specifically, the seamless detection unit 107 detects that the position at which the dummy packet is inserted into the TS is a stream boundary in the visual streams and the audio streams that are decoded by the first visual decoding unit 110, the first audio decoding unit 111, the second visual decoding unit 112, and the second audio decoding unit 113 that are specified by Buffer_indicate 215, in the visual streams and audio streams that are separated by the DEMUX unit 106.

In addition, the seamless detection unit 107 detects the type of seamless reproduction indicated by Dummy_ID 214. In addition, the seamless detection unit 107 detects SubSequenceNo 213.

The seamless detection unit 107 outputs to the decoding control unit 108, the information indicated by SubSequenceNo 213, Dummy_ID 214, and Buffer_indicate 215.

In addition, the decoding control unit 108 instructs the DEMUX unit 106 to perform multiplexing separation, based on the instruction from the reproduction control unit 102. In addition, the decoding control unit 108 instructs the decoding unit 109 to perform decoding, based on the information indicated by SubSequenceNo 213, Dummy_ID 214, and Buffer_indicate 215 that are outputted by the seamless detection unit 107.

Specifically, the decoding control unit 108 associates SubSequenceNo 213 detected by the seamless detection unit 107 with each of the visual streams and the audio streams separated by the DEMUX unit 106.

The decoding unit 109 decodes, in parallel, plural visual streams and plural audio streams that are separated by the DEMUX unit 106. Here, the decoding unit 109 decodes two visual data and two audio data in parallel. For example, the decoding unit 109 includes a decoding circuit for decoding the visual data and a decoding circuit for decoding the audio data, and processes, in parallel, the two visual data and the two audio data by time division, respectively, using the decoding circuits.

The decoding unit 109 includes the first visual decoding unit 110, the first audio decoding unit 111, the second visual decoding unit 112, and the second audio decoding unit 113.

Each of the plural video streams and plural audio streams that have been separated by the DEMUX unit 106 are inputted into a corresponding one of the first visual decoding unit 110, the first audio decoding unit 111, the second visual decoding unit 112, and the second audio decoding unit 113. The first visual decoding unit 110, the first audio decoding unit 111, the second visual decoding unit 112, and the second audio decoding unit 113 decode the inputted visual streams or audio streams into visual data and audio data that are reproducible and displayable (a video picture and an audio frame).

The first visual decoding unit 110 and the second visual decoding unit 112 decode the visual streams separated by the DEMUX unit 106. The first audio decoding unit 111 and the second audio decoding unit 113 decode the audio streams separated by the DEMUX unit 106

In addition, the first visual decoding unit 110, the first audio decoding unit 111, the second visual decoding unit 112, and the second audio decoding unit 113 perform seamless reproduction on the stream boundary detected by the seamless detection unit and included in the decoded visual and audio data. In other words, the first visual decoding unit 110, the first audio decoding unit 111, the second visual decoding unit 112, and the second audio decoding unit 113 perform seamless reproduction on the visual data or the audio data, based on, as the stream boundary, the position at which the dummy packet is inserted. Here, the seamless reproduction is processing for reproducing images and sound without interruption.

In addition, the first visual decoding unit 110, the first audio decoding unit 111, the second visual decoding unit 112, and the second audio decoding unit 113 perform seamless reproduction on the visual data and the audio data, assuming that the visual data and the audio data that are associated with the same SubSequenceNo 213 by the decoding control unit 108 are to be reproduced at the same time.

In addition, the first visual decoding unit 110, the first audio decoding unit 111, the second visual decoding unit 112, and the second audio decoding unit 113 perform seamless reproduction of the type specified by Dummy_ID 214.

The AV input-output control unit 114 instructs the AV input-output control unit 114 to perform an AV input and output, based on the instruction from the reproduction control unit 102.

The AV input-output unit 115 outputs visual data and audio data that are reproducible and displayable after being decoded and seamlessly reproduced by the decoding unit 109. For example, the visual data outputted by the AV input-output unit 115 is outputted to a monitor, and the audio data is outputted from a speaker.

Next, a configuration of the video decoding device 100 according to the embodiment of the present invention is described.

The four examples of operation of the video decoding device 100 are described below.

First, as a first example of operation, an example of operation performed by the video decoding device 100 when performing In-mux is described. Specifically, a video stream 131 in which visual data streams and audio data streams of the main image 200 and the sub image 201 are multiplexed is transferred from the recording medium (BD) 120.

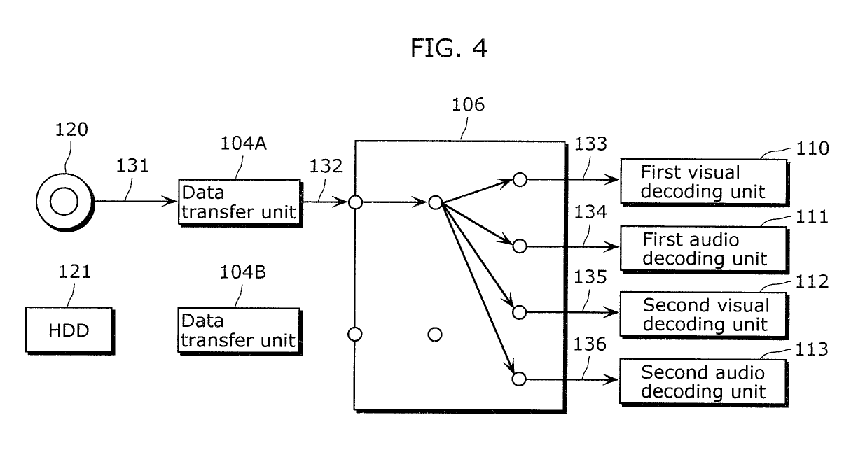

FIG. 4 is a diagram showing a flow of streams in the first example of operation.

As FIG. 4 shows, first, the video stream 131 that is a transport stream is transferred from the recording medium 120 and the HDD 121.

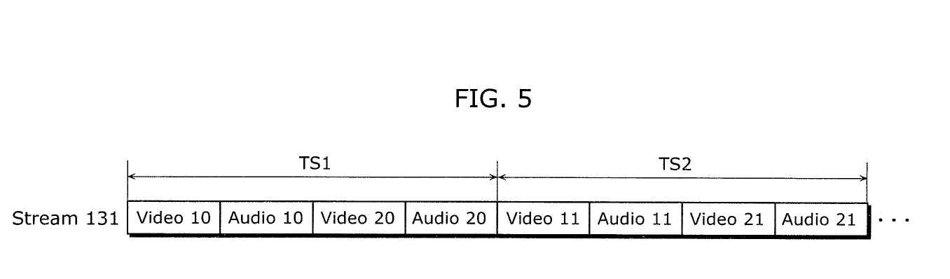

FIG. 5 is a diagram showing an example of the configuration of the video stream 131.

As FIG. 5 shows, the video stream 131 includes TS1 and TS2. Here, TS1 and TS2 are sections included in the video stream 131, and are streams (sections) temporally unsequential to each other.

That is, at the end of TS1, the visual data and the audio data do not always end at the same time. Likewise, at the beginning of TS2, the visual data and the audio data do not always start at the same time. With this, reproducing TS1 and TS2 directly as they come causes a problem of interruption in either images or sound, or overlapping of images and sound.

TS1 includes Video 10 and Video 20 that are visual data packets, and Audio 10 and Audio 20 that are audio data packets.

TS2 includes Video 11 and Video 21 that are visual data packets, and Audio 11 and Audio 21 that are audio data packets. For the TS, each packet (TS packet) is fixed-length data of 188 bytes.

Here, Video 10, Audio 10, Video 20, and Audio 20 are the visual and audio data to be outputted at the same time. Video 11, Audio 11, Video 21, and Audio 21 are the visual and audio data to be outputted at the same time.

In addition, Video 10 and Video 11 are the visual data of the main image 200, and Video 20 and Video 21 are the visual data of the sub image 201. Audio 10 and Audio 11 are the audio data of the main image 200, and Audio 20 and Audio 21 are the audio data of the sub image 201.

Note that an example where each of the sections TS1 and TS2 includes one visual data packet and one audio data packet which correspond, respectively, to the main image 200 and the sub image 201 is described here, but each of the sections TS1 and TS2 may include two or more visual data packets and two or more audio data packets which correspond to the main image 200 and the sub image 201, respectively.

The dummy-packet inserting unit 105A inserts dummy packets, one at a position immediately preceding TS1 of the video stream 131, and one between TS1 and TS2.

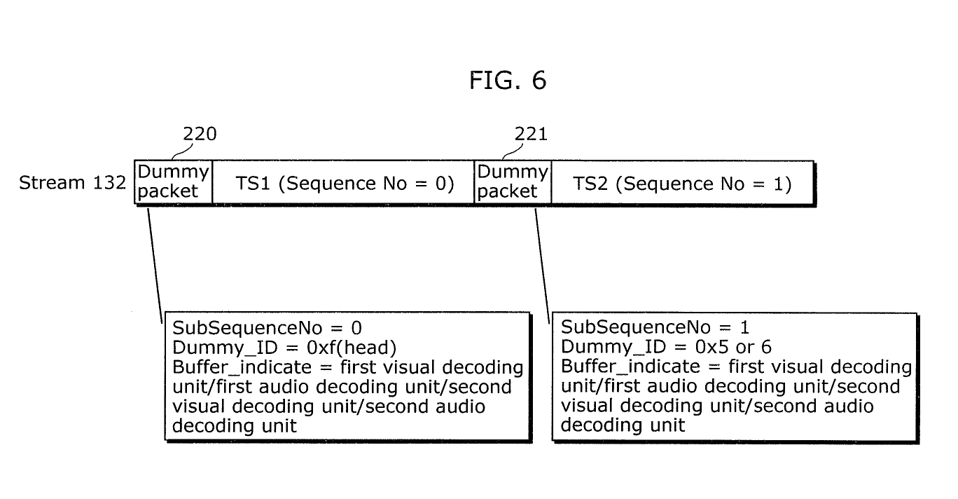

FIG. 6 is a diagram showing an example of the configuration of the video stream 132 after the dummy packet is inserted by the dummy-packet inserting unit 105A.

As FIG. 6 shows, the dummy-packet inserting unit 105A inserts a dummy packet 220 at a position immediately preceding TS1, and a dummy packet 221 between TS1 and TS2.

In the dummy packet 220, SubSequenceNo 213 is “0” and Dummy_ID 214 is “0xf”. Dummy_ID 214 “0xf” indicates that the immediately succeeding section TS1 is at the head of the stream.

In the dummy packet 221, SubSequenceNo 213 is “1” and Dummy_ID 214 is “0x5” or “0x6”. Dummy_ID 214 “0x5” indicates that the visual data and audio data that are included in the sections TS1 and TS2 immediately preceding and succeeding the dummy packet 221 have overlapping data at the stream boundary and that the PTS is not sequential. For example, this corresponds to the case where overlapping of the audio data is caused at the end of TS1 and at the beginning of TS2, when the audio data included in TS1 is longer than the visual data and when the visual data is sequentially reproduced at the stream boundary.

Dummy_ID 214 “0x6” indicates that the visual data and the audio data included in the TS in the sections preceding and succeeding the dummy packets 221 and 223 are originally one sequential stream, and that the PTS is sequential at the stream boundary.

In addition, in the dummy packets 220 and 221, Buffer_indicate 215 specifies: the first visual decoding unit 110, the first audio decoding unit 111, the second visual decoding unit 112, and the second audio decoding unit 113.

The DEMUX unit 106 separates the video stream 132, and outputs, to the decoding unit 109, elementary streams that are visual streams 113 and 135 and audio streams 134 and 135.

The seamless detection unit 107 detects the dummy packets 220 and 221 that are included in the video stream 132.

Since Buffer_indicate 215 specifies all the decoding units (the first visual decoding unit 110, the first audio decoding unit 111, the second visual decoding unit 112, and the second audio decoding unit 113), the seamless detection unit 107 detects that the position at which the dummy packet 221 is inserted is the stream boundary in the visual streams 133 and 135, and in the audio streams 134 and 136.

In addition, the seamless detection unit 107 detects the type of seamless reproduction indicated by Dummy_ID 214. In addition, the seamless detection unit 107 detects SubSequenceNo 213

The seamless detection unit 107 outputs to the decoding control unit 108, information indicated by SubSequenceNo 213, Dummy_ID 214, and Buffer_indicate 215 that are included in the dummy packets 220 and 221.

The decoding control unit 108 associates the detected SubSequenceNo213 with each of the visual streams 133 and 135, and the audio streams 134 and 136. Specifically, the decoding control unit 108 associates SubSequenceNo=“0” included in the dummy packet 220 with Video 10, Audio 10, Video 20, and Audio 20 that are included in TS1. The decoding control unit 108 associates SubSequenceNo=“1” included in the dummy packet 221 with Video 11, Audio 11, Video 21, and Audio 21 that are included in TS2.

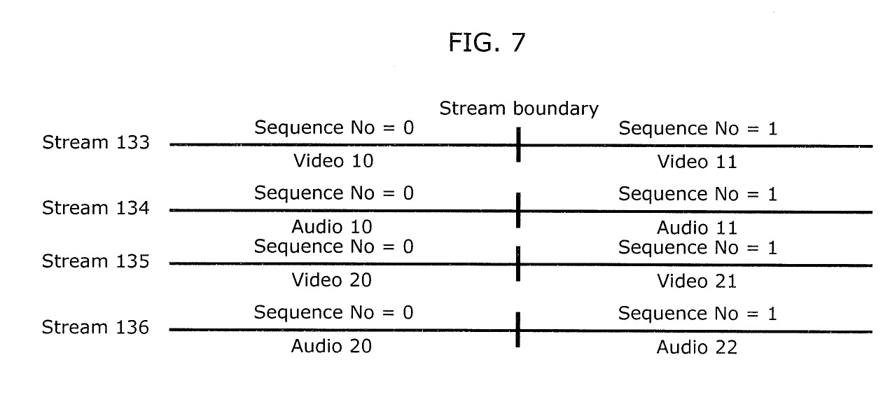

FIG. 7 is a diagram showing an example of the configuration of the visual streams 113 and 135, and the audio streams 134 and 136.

As FIG. 7 shows, the visual stream 133 includes Video 10 and Video 11, the audio stream 134 includes Audio 10 and Audio 11, the visual stream 135 includes Video 20 and Video 21, and the audio stream 135 includes Audio 20 and Audio 21.

Each of the visual streams 133 and 135 and the audio streams 134 and 136 which have been outputted by the DEMUX unit 106 is temporarily stored in a corresponding buffer (not shown) included in each of the first visual decoding unit 110, the second visual decoding unit 112, the first audio decoding unit 111, and the second audio decoding unit 113.

The decoding unit 109 decodes, in parallel, the visual streams 133 and 135 and audio streams 134 and 136 according to an instruction from the decoding control unit 108.

Specifically, the first visual decoding unit 110, the first audio decoding unit 111, the second visual decoding unit 112, and the second audio decoding unit 113 decode, respectively, the visual stream 133, the audio stream 134, the visual stream 135, and the audio stream 136 each of which is held by the corresponding buffer included in each of these units.

In addition, since Buffer_indicate 215 in the dummy packet 221 specifies the first visual decoding unit 110, the first audio decoding unit 111, the second visual decoding unit 112, and the second audio decoding unit 113, the decoding control unit 108 causes the first visual decoding unit 110, the first audio decoding unit 111, the second visual decoding unit 112, and the second audio decoding unit 113 to perform seamless reproduction, based on, as the stream boundary, the position at which the dummy packet 221 is inserted. In other words, the decoding control unit 108 causes the first visual decoding unit 110, the first audio decoding unit 111, the second visual decoding unit 112, and the second audio decoding unit 113 to perform seamless reproduction, based on, as the stream boundary, the position between Video 10 and Video 11, Audio 10 and Audio 11, Video 20 and Video 21, and Audio 20 and Audio 21.

The first visual decoding unit 110, the first audio decoding unit 111, the second visual decoding unit 112, and the second audio decoding unit 113 perform, on the stream boundary, seamless reproduction of the type specified by Dummy_ID 214 included in the dummy packet 221.

Specifically, when Dummy_ID 214 specifies “0x5”, the first visual decoding unit 110, the first audio decoding unit 111, the second visual decoding unit 112, and the second audio decoding unit 113 synchronize the visual data and audio data by performing processing such as skipping overlapped portions of the visual and audio data at the stream boundary. In addition, when Dummy_ID 214 specifies “0x6”, the first visual decoding unit 110, the first audio decoding unit 111, the second visual decoding unit 112, and the second audio decoding unit 113 do not perform the processing described above.

In addition, the first visual decoding unit 110, the first audio decoding unit 111, the second visual decoding unit 112, and the second audio decoding unit 113 perform seamless reproduction on the visual data and the audio data, assuming that the visual data and the audio data that are associated with the same SubSequenceNo 213 by the decoding control unit 108 are to be reproduced at the same time. Here, each of the first visual decoding unit 110, the first audio decoding unit 111, the second visual decoding unit 112, and the second audio decoding unit 113 performs seamless reproduction, assuming that Video 10, Audio 10, Video 20, and Audio 20 are to be reproduced at the same time, and that Video 11, Audio 11, Video 21, and Audio 21 are to be reproduced at the same time.

The AV input-output unit 115 outputs the visual data and audio data that have been decoded and seamlessly reproduced by the first visual decoding unit 110, the first audio decoding unit 111, the second visual decoding unit 112, and the second audio decoding unit 113.

As described above, the video decoding device 100 according to the embodiment of the present invention can decode, at the same time, two video streams (two visual streams and two audio streams) corresponding, respectively, to the main image 200 and the sub image 201 that are included in one video stream 131 and can also perform seamless reproduction on the two video streams.

Next, as a second example of operation, which is an example of In-mux operation as in the case of the first example of operation, the case will be described where the stream boundary is present in only a part of the streams each decoded by the first visual decoding unit 110, the first audio decoding unit 111, the second visual decoding unit 112, and the second audio decoding unit 113. Note that the description that overlaps with the first example of operation will be omitted.

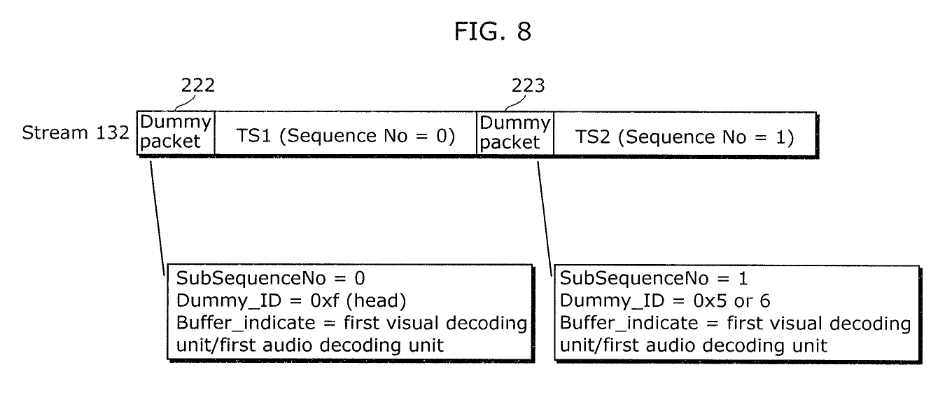

FIG. 8 is a diagram showing an example of the configuration of the video stream 132 in the second example of operation.

As FIG. 8 shows, the dummy-packet inserting unit 105A inserts a dummy packet 222 at a position immediately preceding TS1, and a dummy packet 223 between TS1 and TS2.

In the dummy packets 222 and 223, Buffer_indicate 215 specifies the first visual decoding unit 110 and the first audio decoding unit 111, but does not specify the second visual decoding unit 112 and the second audio decoding unit 113.

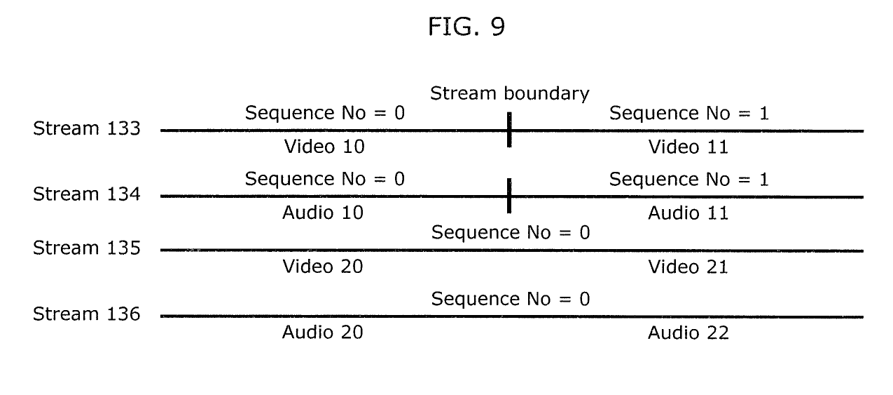

FIG. 9 is a diagram showing an example of the configuration of the visual streams 133 and 135 and audio streams 134 and 136 in the second example of operation.

Since Buffer_indicate 215 in the dummy packet 221 specifies the first visual decoding unit 110 and the first audio decoding unit 111, the decoding control unit 108 causes the first visual decoding unit 110 and the first audio decoding unit 111 to perform seamless reproduction, based on, as the stream boundary, the position at which the dummy packet 221 is inserted.

In addition, since Buffer_indicate 215 in the dummy packet 221 does not specify the second visual decoding unit 112 and the second audio decoding unit 113, the decoding control unit 108 causes the second visual decoding unit 112 to process Video 20 and Video 21 as one sequential stream. In addition, the decoding control unit 108 causes the second audio decoding unit 113 to process Audio 20 and Audio 21 as one sequential stream. In other words, the second visual decoding unit 112 and the second audio decoding unit 113 do not perform seamless reproduction, based on, as the stream boundary, the position at which the dummy packet is inserted.

As described above, the video decoding device 100 according to the embodiment of the present invention can selectively perform seamless reproduction on an arbitrary stream among the plural visual streams 133 and 135 and the plural audio streams 134 and 136 by specifying, in Buffer_indicate 215, an arbitrary decoding unit from among the first visual decoding unit 110, the first audio decoding unit 111, the second visual decoding unit 112, and the second audio decoding unit 113, for one video stream 131 including the two video streams that correspond to the main image 200 and the sub image 201, respectively.

Note that an example where the stream boundary is present in the visual stream 133 and audio stream 134 has been described here, but the video decoding device 100 can selectively perform seamless reproduction on an arbitrary stream among the visual streams 133 and 135 and the audio streams 134 and 136.

Next, as a third example of operation, an example of operation performed by the video decoding device 100 when performing Out-of-mux is described. Specifically, a video stream 141 in which the visual data and audio data of the main image 200 are multiplexed is transferred from the recording medium(BD) 120, and a video stream 142 in which the visual data and audio data of the sub image 201 are multiplexed is transferred from the HDD 121. This is the case where, for example, only the main image 200 is recorded on the recording medium 200, and the reproduction apparatus has downloaded via the Internet and so on, and has recorded on the HDD 121, the sub image 201 corresponding to the main image 200.

Note that the description that overlaps with the first and the second examples of operation will be omitted.

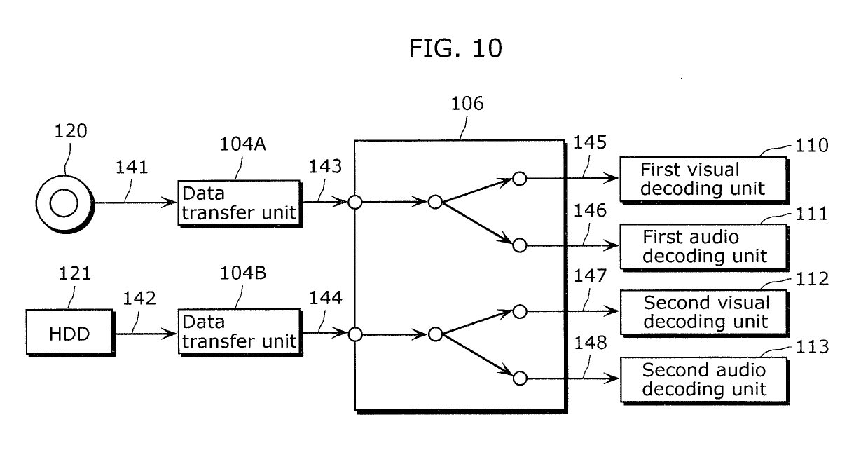

FIG. 10 is a diagram showing a flow of streams in the third example of operation.

As FIG. 10 shows, the video streams 141 and 142 are transferred from the recording medium 120 and the HDD 121, respectively.

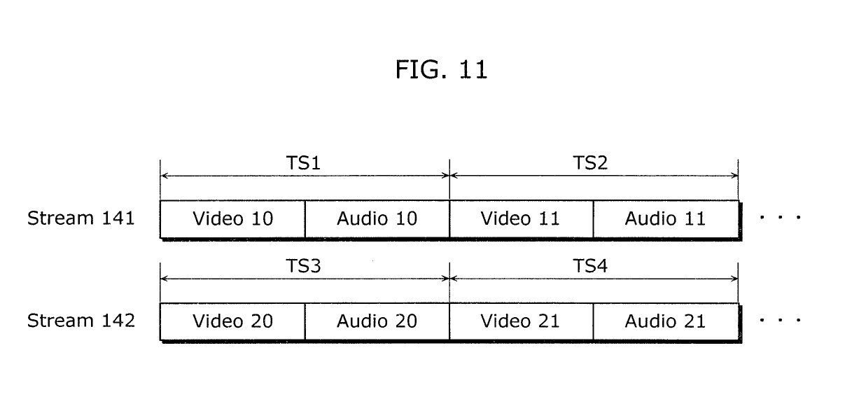

FIG. 11 is a diagram showing an example of the configuration of the video streams 141 and 142.

As FIG. 11 shows, the video stream 141 includes TS1 and TS2 and the stream 142 includes TS3 and TS4. TS1 to TS4 include, respectively, Video 10, Video 11, Video 20, and Video 21 that are visual packets, and Audio 10, Audio 11, Audio 20, and Audio 21 that are audio packets.

In addition, TS1 and TS2 are sections included in the video stream 141 and are streams temporally unsequential to each other. TS3 and TS4 are sections included in the video stream 142 and are streams temporally unsequential to each other.

Here, Video 10, Audio 10, Video 20, and Audio 20 are the visual and audio data to be outputted at the same time. Here, Video 11, Audio 11, Video 21, and Audio 21 are the visual and audio data to be outputted at the same time.

In addition, Video 10 and Video 11 are the visual data of the main image 200, and Video 20 and Video 21 are the visual data of the sub image 201. Audio 10 and Audio 11 are the audio data of the main image 200, and Audio 20 and Audio 21 are the audio data of the sub image 201.

The dummy-packet inserting units 105A and 105B insert a dummy packet into the video streams 141 and 142, respectively, to output video streams 143 and 144.

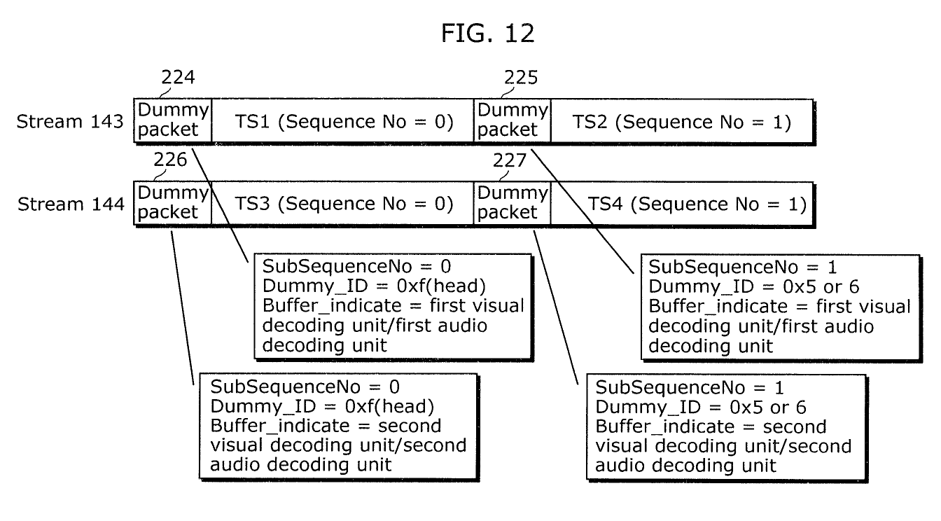

FIG. 12 is a diagram showing an example of the configuration of the video streams 143 and 144.

As FIG. 12 shows, the dummy-packet inserting unit 105A inserts a dummy packet 224 at a position immediately preceding TS1, and a dummy packet 225 between TS1 and TS2. The dummy-packet inserting unit 105B inserts a dummy packet 225 at a position immediately preceding TS3, and a dummy packet 227 between TS3 and TS4.

In the dummy packets 224 and 226, SubSequenceNo 213 is “0” and Dummy_ID 214 is “0xf”. In the dummy packets 225 and 227, SubSequenceNo 213 is “1” and Dummy_ID 214 is “0x5” or “0x6”.

In addition, in the dummy packets 224 and 225, Buffer_indicate 215 specifies the first visual decoding unit 110 and the first audio decoding unit 111. In the dummy packets 226 and 227, Buffer_indicate 215 specifies the second visual decoding unit 112 and the second audio decoding unit 113.

The seamless detection unit 107 detects the dummy packets 224 to 227 that are included in the video streams 143 and 144. The seamless detection unit 107 outputs to the decoding control unit 108, the information indicated by SubSequenceNo 213, Dummy_ID 214, and Buffer_indicate 215 which are included in the dummy packets 224 to 227.

The DEMUX unit 106 separates each of the video streams 143 and 144, and outputs, to the decoding unit 109, elementary streams which are visual streams 145 and 147 and audio streams 146 and 148.

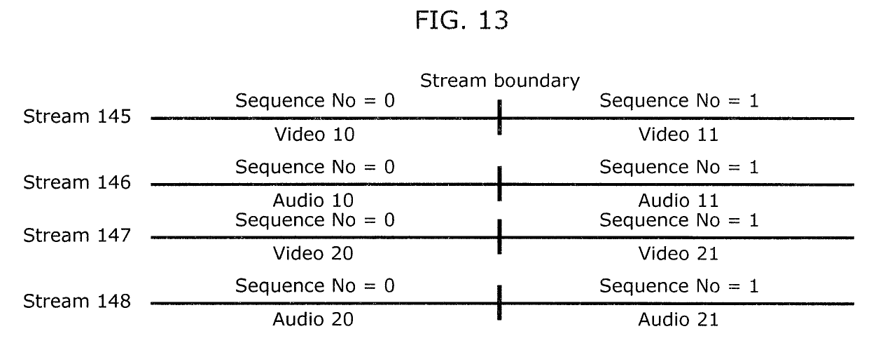

FIG. 13 is a diagram showing examples of the configuration of the visual streams 145 and 147, and the audio streams 146 and 148.

As FIG. 13 shows, the visual stream 145 includes Video 10 and Video 11, the audio stream 146 includes Audio 10 and Audio 11, the visual stream 147 includes Video 20 and Video 21, and the audio stream 148 includes Audio 20 and Audio 21.

The decoding unit 109 decodes, in parallel, the visual streams 145 and 147 and the audio streams 146 and 148 according to an instruction from the decoding control unit 108.

Specifically, since Buffer_indicate 215 in the dummy packet 225 specifies the first visual decoding unit 110, the decoding control unit 108 causes the first visual decoding unit 110 to perform seamless reproduction, based on the position at which the dummy packet 225 is inserted, as the stream boundary between Video 10 and Video 11.

Since Buffer_indicate 215 in the dummy packet 225 specifies the first audio decoding unit 111, the decoding control unit 108 causes the first audio decoding unit 111 to perform seamless reproduction, based on the position at which the dummy packet 225 is inserted, as the stream boundary between Audio 10 and Audio 11.

In addition, the first visual decoding unit 110 and the first audio decoding unit 111 perform, at the stream boundary, the seamless reproduction specified by Dummy_ID 214 included in the dummy packet 225.

Likewise, since Buffer_indicate 215 in the dummy packet 227 specifies the second visual decoding unit 112, the decoding control unit 108 causes the second visual decoding unit 112 to perform seamless reproduction, based on the position at which the dummy packet 227 is inserted, as the stream boundary between Video 20 and Video 21.

Since Buffer indicate 215 in the dummy packet 227 specifies the second audio decoding unit 113, the decoding control unit 108 causes the second audio decoding unit 113 to perform seamless reproduction, based on the position at which the dummy packet 227 is inserted, as the stream boundary between Audio 20 and Audio 21.

In addition, the second visual decoding unit 112 and the second audio decoding unit 113 perform, at the stream boundary, the seamless reproduction specified by Dummy_ID 214 included in the dummy packet 227.

In addition, the first visual decoding unit 110, the first audio decoding unit 111, the second visual decoding unit 112, and the second audio decoding unit 113 perform seamless reproduction on the visual data and the audio data, assuming that the visual data and the audio data that are associated with the same SubSequenceNo 213 by the decoding control unit 108 are to be reproduced at the same time. Here, each of the first visual decoding unit 110, the first audio decoding unit 111, the second visual decoding unit 112, and the second audio decoding unit 113 performs seamless reproduction, assuming that Video 10, Audio 10, Video 20, and Audio 20 are to be reproduced at the same time, and that Video 11, Audio 11, Video 21, and Audio 21 are to be reproduced at the same time.

In other words, the decoding control unit 108 controls, for the visual stream 145 and the audio stream 146 that have been separated from the video stream 143, the seamless reproduction performed by the first visual decoding unit 110 and the first audio decoding unit 111, based on the dummy packet 225 inserted into the video stream 143. In addition, the decoding control unit 108 controls, for the visual stream 147 and the audio stream 148 that have been separated from the video stream 144, the seamless reproduction performed by the second visual decoding unit 112 and the second audio decoding unit 113, based on the dummy packet 227 inserted into the video stream 144.

As described above, the video decoding device 100 according to the embodiment of the present invention can decode, at the same time, the video stream 114 corresponding to the main image 200 and the video stream 142 corresponding to the sub image 201 that are transferred, respectively, from the recording medium 120 and the HDD 121, and can also perform seamless reproduction on the two video streams 141 and 142.

Note that in the third example of operation, an example where the stream boundary is present in each of the visual streams 145 and 147 and the audio streams 146 and 148 has been described, but it is also possible, as in the second example of operation, not to cause the seamless reproduction to be performed, by not specifying the decoding unit in Buffer_indicate 215.

That is, the video decoding device 100 according to the embodiment of the present invention can selectively perform seamless reproduction on an arbitrary stream among the plural visual streams 145 and 147 and the plural audio streams 146 and 148 by specifying, in Buffer_indicate 215, an arbitrary decoding unit from among the first visual decoding unit 110, the first audio decoding unit 111, the second visual decoding unit 112, and the second audio decoding unit 113, for each of the two video streams 141 and 142.

In addition, the video decoding device 100 can determine the visual data and the audio data that are included in the two video streams 141 and 142 and are to be simultaneously reproduced, by referring to SubSequenceNo 213 included in the dummy packet.

Next, as the fourth example of operation, which is another Out-of-mux example, the case will be described where the stream 141 in which the visual data streams of the main image 200 and the sub image 201 are multiplexed is transferred from the recording medium (BD) 120, and the stream 132 in which the audio data streams of the main image 200 and the sub image 201 are multiplexed is transferred from the HDD 121.

This is the case where only the visual data to be reproduced is recorded on the recording medium 120, and the reproduction apparatus has downloaded, via the Internet and so on, and has recorded on the HDD 21, audio data corresponding to the visual data. For example, when only the visual data corresponding to the main image 200 and the sub image 201 and the audio data in Japanese and English are recorded on the recording medium 120, and when French is specified as the audio language by the user of the reproduction apparatus, the audio data in French corresponding to the main image 200 and the sub image 201 are downloaded via the Internet and so on to be recorded on the HDD 121.

Note that the description that overlaps with the first, the second, and the third examples of operation will be omitted.

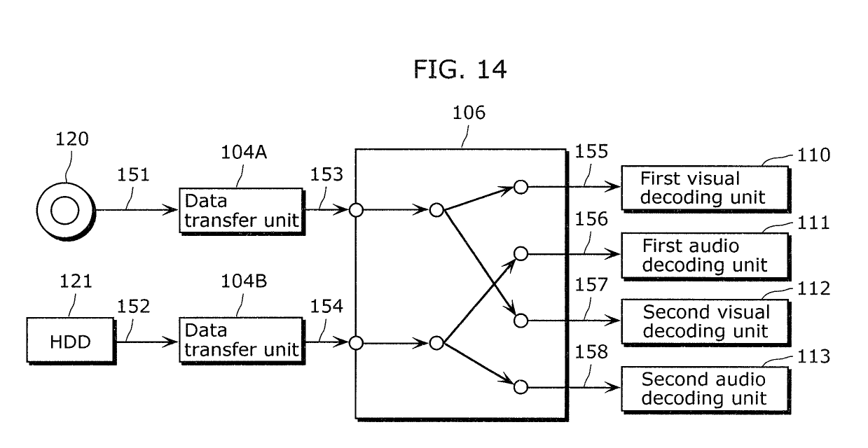

FIG. 14 is a diagram showing a flow of streams in the fourth example of operation.

As FIG. 14 shows, streams 151 and 152, each of which is TS, are transferred from the recording medium 120 and the HDD 121, respectively.

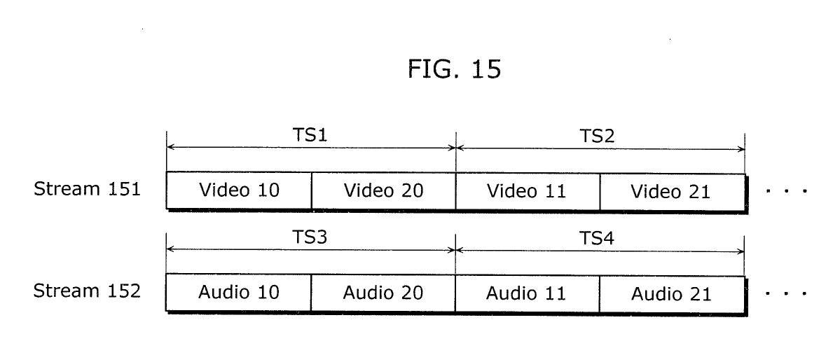

FIG. 15 is a diagram showing an example of the configuration of the streams 151 and 152.

As FIG. 15 shows, the stream 151 includes TS1 and TS2, and the stream 152 includes TS3 and TS4. TS1 includes Video 10 and Video 20, TS2 includes Video 11 and Video 21, TS3 includes Audio 10 and Audio 20, and TS4 includes Audio 11 and Audio 21.

In addition, TS1 and TS2 are sections included in the stream 151 and are streams temporally unsequential to each other. TS3 and TS4 are sections included in the stream 152 and are streams temporally unsequential to each other.

Here, Video 10, Audio 10, Video 20, and Audio 20 are the visual and audio data to be outputted at the same time. Video 11, Audio 11, Video 21, and Audio 21 are the visual and audio data to be outputted at the same time.

In addition, Video 10 and Video 11 are the visual data of the main image 200, and Video 20 and Video 21 are the visual data of the sub image 201. Audio 10 and Audio 11 are the audio data of the main image 200, and Audio 20 and Audio 21 are the audio data of the sub image 201.

The dummy-packet inserting units 105A and 105B insert a dummy packet into the video streams 151 and 152, respectively, to output video streams 153 and 154.

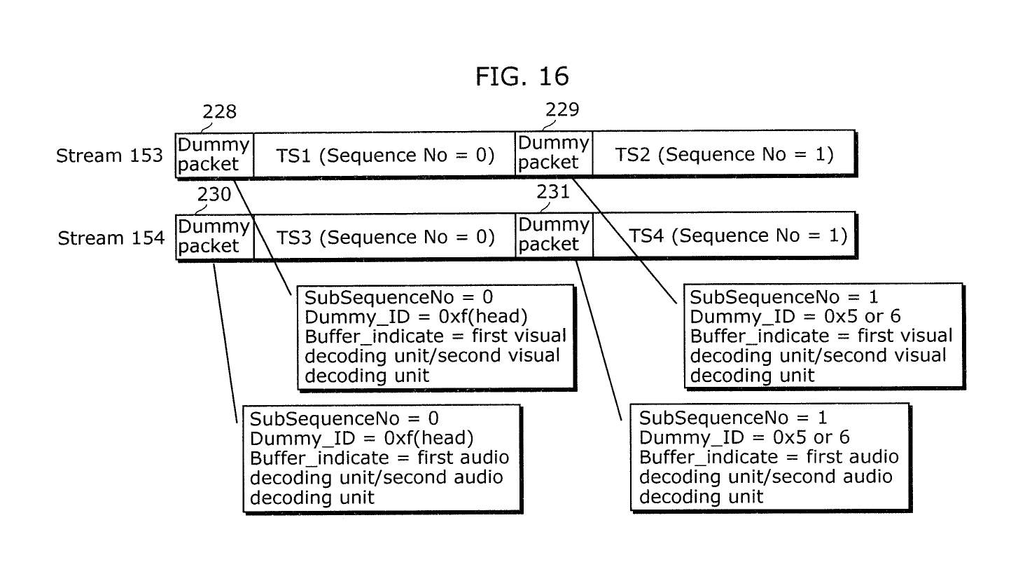

FIG. 16 is a diagram showing an example of the configuration of the streams 153 and 154.

As FIG. 16 shows, the dummy-packet inserting unit 105A inserts a dummy packet 228 at a position immediately preceding TS1, and a dummy packet 229 between TS1 and TS2. The dummy-packet inserting unit 105B inserts a dummy packet 230 at a position immediately preceding TS3, and a dummy packet 231 between TS3 and TS4.

In the dummy packets 228 and 230, SubSequenceNo 213 is “0” and Dummy_ID 214 is “0xf”. In the dummy packets 229 and 231, SubSequenceNo 213 is “1” and Dummy_ID 214 is “0x5” or “0x6”.

In addition, in the dummy packets 228 and 229, Buffer_indicate 215 specifies the first visual decoding unit 110 and the second visual decoding unit 112. In the dummy packets 230 and 231, Buffer_indicate 215 specifies the first audio decoding unit 111 and the second audio decoding unit 113.

The DEMUX unit 106 separates the video streams 153 and 154, and outputs, to the decoding unit 109, elementary streams that are visual streams 155 and 157 and audio streams 156 and 158.

Note that the configuration of the visual streams 155 and 157 and the audio streams 156 and 158 are the same as those of the visual streams 145 and 147 and the audio streams 146 and 147 that are shown in FIG. 13.

The decoding unit 109 decodes, in parallel, the visual streams 155 and 157 and the audio streams 156 and 158, according to an instruction from the decoding control unit 108.

Specifically, since Buffer_indicate 215 in the dummy packet 229 specifies the first visual decoding unit 110 and the second visual decoding unit 112, the decoding control unit 108 causes the first visual decoding unit 110 and the second visual decoding unit 112 to perform seamless reproduction, based on, as the stream boundary, the position at which the dummy packet 229 is inserted.

Since Buffer_indicate 215 in the dummy packet 231 specifies the first audio decoding unit 111 and the second audio decoding unit 113, the decoding control unit 108 causes the first audio decoding unit 111 and the second audio decoding unit 113 to perform seamless reproduction, based on, as the stream boundary, the position at which the dummy packet 231 is inserted.

In addition, the first visual decoding unit 110, the first audio decoding unit 111, the second visual decoding unit 112, and the second audio decoding unit 113 perform seamless reproduction on the visual and audio data, assuming that the visual data and audio data that are associated with the same SubSequenceNo 213 by the decoding control unit 108 are to be reproduced at the same time. Here, each of the first visual decoding unit 110, the first audio decoding unit 111, the second visual decoding unit 112, and the second audio decoding unit 113 performs seamless reproduction, assuming that Video 10, Audio 10, Video 20, and Audio 20 are to be reproduced at the same time, and that Video 11, Audio 11, Video 21, and Audio 21 are to be reproduced at the same time.

As described above, the video decoding device 100 according to the embodiment of the present invention can decode, at the same time, the visual stream and the audio stream that correspond, respectively, to the main image 200 and the sub image 201, in the case where the stream 151 in which the visual data corresponding to the main image 200 and the sub image 201 are multiplexed and the stream 152 in which the audio data corresponding to the main image 200 and the sub image 201 are multiplexed are inputted, respectively, from the recording medium 120 and HDD 121, and can also perform seamless reproduction.

Note that in the fourth example of operation, an example where the stream boundary is present in each of the visual streams 155 and 157 and the audio streams 156 and 158 has been described, but it is also possible, as in the second example of operation, not to cause the seamless reproduction to be performed, by not specifying the decoding unit in Buffer_indicate 215.

That is, the video decoding device 100 according to the embodiment of the present invention can selectively perform seamless reproduction on an arbitrary stream among the plural visual streams 155 and 157 and the plural audio streams 156 and 158 by specifying, in Buffer_indicate 215, an arbitrary decoding unit from among the first visual decoding unit 110, the first audio decoding unit 111, the second visual decoding unit 112, and the second audio decoding unit 113, for each of the two video streams 151 and 152.

In addition, the video decoding device 100 can determine the visual data and the audio data that are included in the two video streams 151 and 152 and are to be reproduced at the same time, by referring to SubSequenceNo 213 included in the dummy packet.

Thus far, a video decoding device according to the embodiment of the present invention has been described, but the present invention is not limited to this embodiment.

For example, in the above description, the third and the fourth examples of operation have been described as examples of Out-of-mux operation, but any combination may be used for combining the visual and audio streams which are multiplexed in the two video streams transmitted from the recording medium 120 and the HDD 121 and which correspond to the main image 200 and the sub image 201, respectively. In addition, three of the visual and audio streams each corresponding to one of the main image 200 and the sub image 201 may be multiplexed in one of the two video streams transmitted from the recording medium 120 and the HDD 121, and the remaining one may be included in the other video stream.

In addition, the video decoding device 100 described above has a function to decode the two streams at the same time, but may also have a function to decode more than two video streams at the same time.

In addition, the decoding unit 109 described above decodes plural visual streams and audio streams by time division, but may also include plural decoding circuits which can decode the visual and audio streams in parallel so as to decode such plural visual and audio data at the same time.

In addition, an example where transport streams are transferred from the recording medium 120(BD) and the HDD 121 has been described above, but the transport streams may be transferred from an arbitrary recording medium or memory. For example, the transport streams may be transferred from a recording medium other than the BD, such as an optical disk and a memory card, and may also be transferred from a nonvolatile memory, a RAM, and so on included in the reproduction apparatus. In addition, a transport stream may be transferred from each of two recording media. Furthermore, two transport streams may be transferred from one transfer source.

In addition, the dummy-packet inserting units 105A and 105B as described above each insert a dummy packet between sections in the TS, but may also insert two or more dummy packets by dividing the above-described information included in the dummy packet.

### INDUSTRIAL APPLICABILITY

The present invention is applicable to a video decoding device, and is particularly applicable to a video reproduction apparatus such as a BD player and a DVD player having a function to reproduce a BD.

1. A video decoding device which decodes, in parallel, a first visual data stream, a second visual data stream, a first audio data stream, and a second audio data stream which are multiplexed in one or more video data streams divided into sections and which are to be simultaneously reproduced, said video decoding device comprising:
a dummy-packet inserting unit configured to insert a dummy packet into a boundary between the sections in the one or more video data streams;
a separating unit configured to separate the one or more data streams into which the dummy packet is inserted by said dummy-packet inserting unit, into the first visual data stream, the second visual data stream, the first audio data stream, and the second audio data stream;
a detection unit configured to detect a position at which the dummy packet is inserted as a boundary between the first visual data stream, the second visual data stream, the first audio data stream, and the second audio data stream that have been separated from each other by said separating unit;
a first visual decoding unit configured to decode the first visual data stream separated by said separating unit, and to perform, on the boundary detected by said detection unit, processing for reproducing images without interruption;
a second visual decoding unit configured to decode the second visual data stream separated by said separating unit, and to perform, on the boundary detected by said detection unit, the processing for reproducing images without interruption;
a first audio decoding unit configured to decode the first audio data stream separated by said separating unit, and to perform, on the boundary detected by said detection unit, processing for reproducing sound without interruption; and
a second audio decoding unit configured to decode the second audio data stream separated by said separating unit, and to perform, on the boundary detected by said detection unit, the processing for reproducing sound without interruption.

2. The video decoding device according to claim 1,
wherein said dummy-packet inserting unit is configured to insert the dummy packet including first information that indicates whether or not to specify each of said first visual decoding unit, said second visual decoding unit, said first audio decoding unit, and said second audio decoding unit, and
said first visual decoding unit, said second visual decoding unit, said first audio decoding unit, and said second audio decoding unit are configured to perform, when specified by the first information, the processing for reproducing the images or the sound without interruption, on the boundary detected by said detection unit.

3. The video decoding device according to claim 1,
wherein said dummy-packet inserting unit is configured to insert the dummy packet including second information that indicates a type of the processing for reproducing the images or the sound without interruption,
said detection unit is further configured to detect the type of the processing for reproducing the images or the sound without interruption, the type being indicated by the second information, and
said first visual decoding unit, said second visual decoding unit, said first audio decoding unit, and said second audio decoding unit are configured to perform, on the boundary detected by said detection unit, the processing according to the type for reproducing the images or the sound without interruption, the type being detected by said detection unit.

4. The video decoding device according to claim 1,
wherein said dummy-packet inserting unit is configured to insert the dummy packet including third information for identifying one of the sections that is located immediately after the dummy packet,
said detection unit is configured to detect the third information included in the dummy packet, and to associate the detected third information with each of the first visual data stream, the second visual data stream, the first audio data stream, and the second audio data stream that have been separated from each other by said separating unit, and
said first visual decoding unit, said second visual decoding unit, said first audio decoding unit, and said second audio decoding unit are configured to perform the processing for reproducing the images or the sound without interruption, on the first visual data stream, the second visual data stream, the first audio data stream, and the second audio data stream, assuming that the first visual data stream, the second visual data stream, the first audio data stream, and the second audio data stream that are associated with same third information are to be reproduced at a same time.

5. A video decoding method for decoding, in parallel, a first visual data stream, a second visual data stream, a first audio data stream, and a second audio data stream which are multiplexed in one or more video data streams divided into sections and which are to be simultaneously reproduced, said video decoding method comprising:
inserting a dummy packet into a boundary between the sections in the one or more video data streams;
separating the one or more data streams into which the dummy packet is inserted, into the first visual data stream, the second visual data stream, the first audio data stream, and the second audio data stream;
detecting a position at which the dummy packet is inserted as a boundary between the first visual data stream, the second visual data stream, the first audio data stream, and the second audio data stream that have been separated from each other in said separating; and
decoding, in parallel, the first visual data stream, the second visual data stream, the first audio data stream, and the second audio data stream that have been separated from each other in said separating, and performing, on the boundary detected in said detecting, processing for reproducing images and sound without interruption.

6. A program for decoding, in parallel, a first visual data stream, a second visual data stream, a first audio data stream, and a second audio data stream which are multiplexed in one or more video data streams divided into sections and which are to be simultaneously reproduced, said program causing a computer to execute:
inserting a dummy packet into a boundary between the sections in the one or more video data streams;
separating the one or more data streams into which the dummy packet is inserted, into the first visual data stream, the second visual data stream, the first audio data stream, and the second audio data stream;
detecting a position at which the dummy packet is inserted as a boundary between the first visual data stream, the second visual data stream, the first audio data stream, and the second audio data stream that have been separated from each other in the separating; and
decoding, in parallel, the first visual data stream, the second visual data stream, the first audio data stream, and the second audio data stream that have been separated from each other in the separating, and performing, on the boundary detected in the detecting, processing for reproducing images and sound without interruption.
